(19) United States
(12) Patent Application Publication
(10) Pub. No.: US 2012/0174655 A1
(43) Pub. Date: Jul. 12, 2012

(54) Contaminated water detecting and monitoring and warning device and system and method using single sensors in tandem or cascade

(75) Inventor: Eberhard Essich, Cleveland, GA (US)

(73) Assignee: EBERHARD ESSICH, CLEVELAND, GA (US)

(21) Appl. No.: 13/374,539

(22) Filed: Jan. 3, 2012

Related U.S. Application Data
(60) Provisional application No. 61/461,006, filed on Jan. 12, 2011.

(51) Int. Cl. G01N 11/00

(52) U.S. Cl. 73/53.01

(57) ABSTRACT

This novel device and method provide immediate, direct, reliable, continuous and inexpensive warnings of potential contamination of a water supply to the user. It uses but is not limited to individual or a cascade of water pressure, turbidity, and total dissolved solids detectors to trigger audible and visual alarms and warn the user at the point of use and at remote sites, of damage to or intrusion into their water distribution system and thereby their water supply. It can be installed into any existing or new system with minimal expertise. It can be used to notify authorities of such problems without any action on the part of the user.

This application claims benefit of Provisional Patent Application 61/461,006 filed Jan. 12, 2011

### CROSS REFERENCE TO RELATED APPLICATIONS

Not Applicable

| | | | |
|---|---|---|---|
| 7,759,984 | July 2010 | Tischendorf, et al | 324/694 |
| 7,104,115 | September 2006 | Kahn, et al | |
| 7,100,427 | September 2006 | Kahn, et al | 73/53.01 |
| 5,580,444 | December 1996 | Burrows | |
| 5,145,575 | September 1992 | Burrows | |
| 5,045,197 | September 1991 | Burrows | 210/321.78 |
| 4,849,098 | July 1989 | Wilcock, et al | |

### FEDERALLY SPONSORED RESEARCH

None

### SEQUENCE LISTING

None

### BACKGROUND

While testing water for the public it came to my attention that several families in our area became sick from drinking or cooking with water from their municipal source despite advisories by the local municipality to “boil water” before use. As it turned out these individuals did not hear of the advisory or in other cases did not get the information until after having consumed the water. After considerable searching I found that there is no “early warning” system that addresses this problem. Consumers are dependent upon local water authorities to identify a problem with the water or water distribution system, notification of the local news outlets, announcements on the radio and television, before the public even becomes aware of a problem. This process takes a minimum of 8 to 12 hours and can take days before a problem is discovered and a “boil water advisory” issued. And even then, not every home on the distribution system will need to boil their water because some will be unaffected, but the authorities will have no way to know this and will issue a blanket boil water advisory that will include those who may not need to boil their water. As such they will have created “false positives”, ie, people boiling their water when it is not necessary. This invention provides each homeowner with their own in-line detection device that can report to the homeowner immediately that there is a problem or was a problem earlier in the day, with the water in their distribution system and therefore the quality of their water. In essence this is a monitoring system that monitors one to three parameters (three parameters being preferred) of the water in the user's water distribution system and notifies him or her immediately if any of these parameters deviate from their normal range and thus indicate a problem with the water distribution system and the water itself. A homeowner could arrive home one day, find a red warning lamp above the sink indicating that their water or water distribution system has been compromised, and could immediately begin boiling their water or making inquiries to their local water distributor to find out what the problem is, or alternatively to notify the local water distributor that there is a problem of which they may not be aware. The system has a reset for each parameter so they could immediately reset the warning lamps and alarms, which would provide them with information about whether the problem still exists or has been remedied. Such a device will not only prevent sickness but may actually save lives of the elderly, very young, cancer patients undergoing chemotherapy and others who are more susceptible to water-borne illnesses, but could also thwart efforts of bioterrorists who are secretly trying to introduce a chemical or biological agent into the water of a distribution system

In one embodiment a simple test for hydrostatic pressure in the system would detect a break in a water main and a visual and audible warning at the point of use, usually the kitchen sink, would warn the user that there had been a significant or dangerous pressure drop in the system. A second embodiment might measure turbidity or both water pressure and turbidity, or first water pressure and trigger the measurement of turbidity if the water pressure goes outside the normal, acceptable, range, measuring both water pressure and turbidity only after the first parameter (water pressure) is abnormal. A third embodiment might measure water pressure, turbidity and total dissolved solids or electrical conductivity of the water either individually or in tandem or a cascade in which the first measurement, if the departure is outside normal acceptable preset bounds, would trigger measurement of the second parameter, which if excursion is outside normal acceptable preset bounds would trigger measurement of the third parameter. Each parameter that is out of range would produce a respective visual and audio warning at the most common point of use. Other more and less complex embodiments can be easily imagined and would fall within the scope of this invention and patent.

All broken water lines, whether accidentally or intentionally damaged are accompanied by in-line water pressure drops in the distribution system. Intentional breaks, for purposes of repair by the water company for example, are accompanied by pressure drops to approximately 20 psi (pounds per square inch). Accidental breaks are accompanied by pressure drops as low as zero psi. All open water lines are accompanied by a severe drop in in-line pressure. When water pumps that serve wells fail, that failure is accompanied by a pressure drop to zero psi. When water pumps that serve wells go off during a power failure in-line water pressure in the distribution system will fall to some lower value and often to zero. When water pumps malfunction but do not stop operating the malfunction is almost always accompanied by a drop in water pressure in the distribution system. When water pressure in a distribution system drops below that which is normally maintained in the system a reverse of flow of substances from outside and surrounding the system to the inside occurs at every site where there is a faulty seal or a crack or break in the system. This allows for flow of contaminants from surrounding soil and environment into the water being consumed by the user. Such damage occurs frequently both in distribution systems supplied by wells and those supplied by municipal water companies. Municipal suppliers are required to alert the public with “boil water advisories” as soon as they become aware of an insult to the integrity of the system. But no-one can receive those boil water advisories before a break is detected, isolated and its location identified, and this may take hours to days or longer. Meanwhile, and before hearing a boil water advisory on the radio or television the consumer may have no idea that they are consuming potentially contaminated water. Homeowners and businesses or industries with wells often cannot know when a freeze-thaw or physical insult to their system, such as a car driving over their water distribution lines, has caused such damage unless their water pressure drops so radically as to prevent normal use of the water supply, such as showering, dishwashing, washing clothing, cooking etc. A pressure drop of less than 30 or 40 psi may not be detected but will still allow flow of contaminants from the surroundings of the water distribution system into the water lines and thereby potentially contaminate the system with bacteria, toxins, and various other substances. Users would normally be oblivious to such danger since there is no warning system or method currently available to alert them to the fact that their distribution system is damaged.

When substances enter the water in a water distribution system they almost always cause a change in the clarity or turbidity of the water. This is to be distinguished from the color of the water. Water can assume a color, say blue for example, and yet be crystal clear. It can also become turbid without a color change. Even when there is no change in the water pressure, turbidity changes can immediately alert an individual to the fact that a contaminant has entered the water they are using. A simple example of this is the clarity change that accompanies dirt, soil, or clay entering a system. In Georgia the water may turn reddish brown from such an intrusion but the amount of contaminant that enters the system must be large to be detected by the human eye. A much more sensitive device to detect changes in turbidity in the water is a turbidimeter. Such a device can detect extremely small changes in turbidity caused by sediment, bacteria, chemical reactions and a multitude of other causes, many of which may be due to contaminants that are a danger to the health of the user of the water. A simple, yet extremely sensitive turbidimeter can be constructed using an illumination source such as an LED (light emitting diode) placed in position in the wall of a pipe in the distribution system and a light detector positioned in the wall of the same pipe of the distribution system at some chosen angle from the illuminator. Thus it is a simple and relatively inexpensive matter to make and install such a turbidimeter into a distribution system and use it to detect changes in the turbidity of the water in that system. One scenario where this may be useful is if a bioterrorist, or a simple break in the line, were to introduce a contaminant, either chemical or biological into the system, without producing a significant drop in pressure. If there is a small crack in the system this may be possible, or if someone is introducing a chemical or biological agent but makes a connection in such a way as to increase the pressure in the delivery vessel before opening the valve to the distribution system so that there would be no noticeable water pressure drop in the system as a toxic agent is delivered. Thus it would be very useful to have a second parameter being measured, detected, and reported to the user. Turbidity of water is in fact used as a prime parameter in the detection of contamination of natural water sources by government agencies when such contamination is suspected as the result of any number of different activities including construction, waste disposal, during water purification and for various scientific and environmental studies.

A third parameter that can be measured and has been deemed useful by the USEPA (United States Environmental Protection Agency) as a measure of water quality is the level of total dissolved solids (TDS) in the water. Total dissolved solids include any and all ionizable substances that can conduct electricity through water. This would include metals such as lead, zinc, copper and mercury; minerals such as magnesium, calcium, chloride, potassium; anions such as sulfate, nitrate, ammonia and many other compounds as well. As the concentration of such ions increases in the water, the conductivity of the water to electricity also increases in direct proportion to the amount of the various ions that are present. Even bacteria, viruses and other living and non-living substances can be detected using conductivity measurements. Since conductivity is the inverse of resistivity, if one can be detected, then so can the other. Pure water has a theoretical resistance of 18.2 Megohms and decreases from there in direct proportion to the amount of impurity, in this case ionic impurities, that are present. Hence, it is not novel and it is a simple matter to introduce a total dissolved solids meter into water, take a measurement, and use that measurement as a reference for either increases or decreases or absolute values of ionic compounds in the water. Once again, this parameter is one that has been added by the USEPA to the list of parameters that individual well owners should measure on an annual basis to ascertain the water quality of their well water. It can thus be judged as a reliable indicator of water quality and would be the third parameter that can be easily monitored using an in-line probe. Many companies that make water filtration devices have added such an in-line monitor to their purified water outflow to determine whether or not the water is of sufficient purity to meet their requirements and the requirements of the consumer of the water. Examples can be seen in patents U.S. Pat. No. 5,580,444, Water quality Monitor for a water purification system, Burrows, 3 Dec. 1996; U.S. Pat. No. 5,527,450 water conductivity monitor for a water purification system, Burrows, Jun. 18, 1996; U.S. Pat. No. 5,145,575, water quality monitor for a water purification system, Burrows, Sep. 18, 1992; U.S. Pat. No. 5,057,212, Water conductivity monitor and circuit with extended operating life, Burrows, Oct. 15, 1991; U.S. Pat. No. 4,849,098, Continuous water quality monitor, Wilcock et al., Jul. 18, 1989. Also, many different detectors and electronic components used in this system are available today on the open market. It will not be necessary to describe any of them in detail, as they can be chosen to meet pricing and quality criteria deemed appropriate for embodiments described in this document.

Any of these parameters, pressure, turbidity, conductivity by themselves, are considered by experts in the field, to be sufficiently reliable to monitor and indicate whether a given water quality is good enough for consumption. Taken together any two of these would necessarily be even more reliable than one alone, and all three of these parameters used as measurements of water quality would give a very highly reliable assessment that the water is of good quality, or more important, that its good quality has not changed significantly.

It is one object of this invention to describe at least one system that alerts the user to significant changes in water quality as indicated by changes in one or more of the following parameters water pressure, turbidity and conductivity prior to consumption of that water

Further, it is an object of this invention to provide the user with safeguards against contamination and damage to their water treatment system, home water purification system, washer, refrigerator purification system, water heater and other water utilizing devices in their home.

It is a further object of this invention to provide a system and device that can be used to notify the user and the public of an intrusion into their branch of any water distribution system.

It is a further object of this invention to provide potential for use of individual parameters to track the quality of water in the water distribution system

It is further an object of this invention to bring cost down by using very simple, inexpensive yet reliable materials, parts and methods to reduce cost sufficiently to make such a device affordable and attractive to the average homeowner. Very large drawbacks to testing devices are that they are very expensive and that they are not integrated into the homes water distribution system and that they do not provide advanced warning of contamination and, as such, do the homeowner no good. Advances in technology in the past few years have made it possible, using new technology to improve reliability and reduce cost and the technological advances provided by this new arrangement of and method of use have for one instance, made it possible to extend the life expectancy, efficiency, and reliability of direct water monitoring in the distribution system far beyond anything previously available. A person skilled in the art will be able to see these advances for the advantages they provide.

### SUMMARY OF THE INVENTION

Advantages of our device over prior art include:
1. An affordable system that has been designed to notify homeowners immediately and directly of potential contamination of their water supply using either single or multiple parameters and especially notification before the authorities may even know of and can notify users, of such an intrusion
2. This device is not designed to be used with a purification system as all other monitoring devices are, thus it provides information about the source water not purified water and can warn the consumer of problems with water quality before they use it, not just after a public notification
3. Use of several to three parameters in determination of water purity or changes in water quality which makes the system much more accurate than monitoring for a single parameter
4. Use of several to three parameters in a cascade and in tandem and in any combination of one with another or one with two others makes the system more energy efficient and accurate and conserves components such as electrodes and means for producing light such as LED's and while in theory conductivity measurements can be conducted continuously, in practice corrosion of the detecting element makes conductivity measurements over a long period of time impossible and our three stage system allows for minimizing such corrosion and allowing in actual practice a lifetime of many years for the conductivity testing elements
5. Use of 3 indicators each indicating which of three parameters are exceeding the preset desired range of the particular parameter allows identification of which parameter is out of range and therefore which condition needs to be corrected to bring the water back into acceptable range for a parameter and provides additional information about the severity and extent of the problem
6. Use of 2 or 3 parameters essentially eliminates all “false” positive alarms
7. Use can easily warn of potential accidental or intentional damage to the water distribution systems as may occur by an accidental water main break or a terrorist attack on such a system to introduce a biological or chemical contaminant into the system BEFORE consumers use the water or hear a boil water advisory
8. Use requires no skill or action on the part of the user. All monitoring may be done automatically and all warnings may be provided automatically
9. Use is extremely energy efficient due to use of low energy consuming components
10. Use of the system can be employed by emergency response teams and government agencies for monitoring distribution systems anywhere in the country and monitoring can be done by authorities without intruding on the private citizen
11. Use can include any or all parameters of this system since each parameter is measured independently of the others in at least one embodiment of the invention and can include parameters not explicitly identified in this document such as lead, nitrate, arsenic etc.

### BRIEF DESCRIPTION OF DRAWINGS

FIG. 1: One possible embodiment of the invention with 3 detectors, each monitoring a different parameter, water pressure, turbidity, electrical conductivity, each operating independently to produce a warning signal, both audible and visual at the point of use

FIG. 2: Another embodiment of the invention showing a simple cascade in which the first parameter going outside normal range (ex. Water pressure) triggers a second parameter to be monitored and produce a warning if it exceeds acceptable limits which in turn triggers a third parameter to be monitored using the same arrangement.

FIG. 3: Another embodiment showing utilization of radio signals to communicate between monitoring modules and monitoring stations operated by local authorities.

FIG. 4: Another embodiment showing use of radio signals to communicate between monitoring modules and warning panels at the point of use as well as local authorities

### DETAILED DESCRIPTION

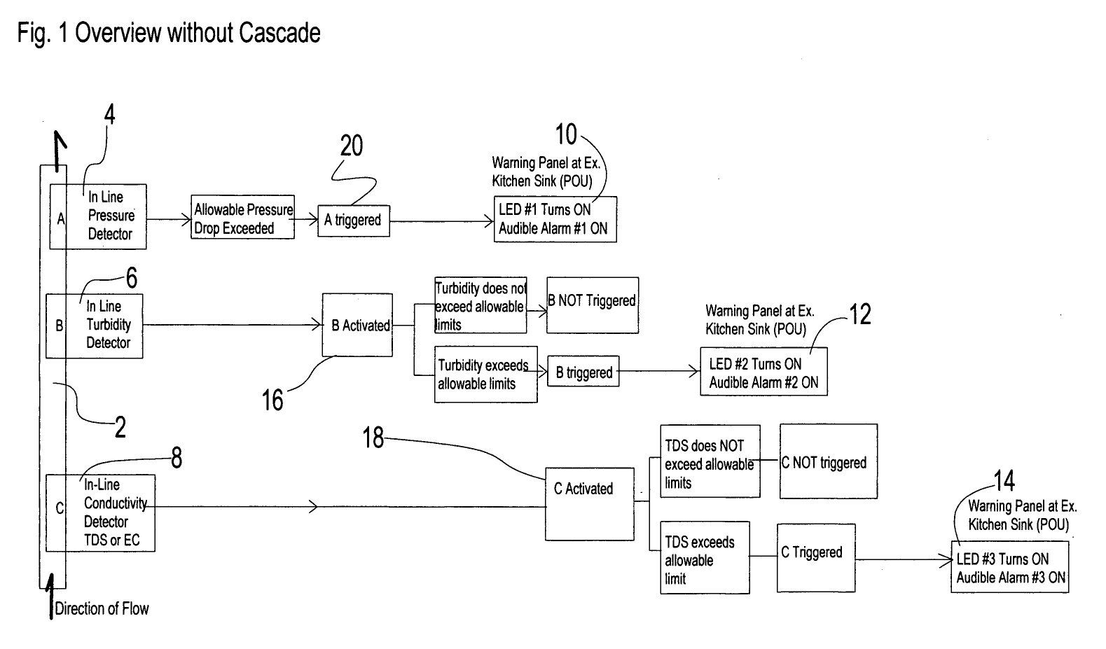

Water enters the home water distribution system from a water main at the road. Shortly thereafter the system is fitted with one or more of several modules. Each module detects a different parameter, those being water pressure, water turbidity and water conductivity or resistance and there may be others. One module detects pressure and is set to a specific pressure below which it is triggered to the power on position. In the on position the module closes a circuit that 1) illuminates an LED at the point of use and 2) sounds an audible alarm at the point of use. This will be referred to as module A or the pressure module and the result is that a warning lamp illuminates at the point of use and an audible alarm sounds at the point of use when the pressure drops below the prescribed limit, warning the consumer directly and immediately that there may be a problem with the quality of his/her water. If the consumer is not available at the time of the occurrence it does not matter because the illuminated LED will remain on and the audible alarm sound will continue until the consumer presses a reset button at the point of use where the alarms are located, thus resetting the device and indicating that they have observed the warning. Referring to FIG. 1 which is a flow chart of how the system operates without a cascade, said cascade will be described later, one can see that 4 is identified as the in line pressure detector switch. As an example if the inline pressure detector switch were set to 20 pounds per square inch (psi) and the pressure in the line dropped to 19 psi, the switch would be triggered (FIG. 1, 20) to the power on position (20) and the LED and audible alarm (10) would be activated making the LED (LED #1) turn on and the audible alarm #1 sound. In one preferred embodiment the in line pressure detector would be the first module to be activated, the turbidimeter would be the second module to be activated and the total dissolved solids (TDS), in-line conductivity or in-line resistivity detector would remain in the off position until both modules A and B had been activated. This being preferred to save the probe in the conductivity detector from unnecessary corrosion and rapid deterioration. This will extend the life of such a probe to many years when it would normally need to be replaced in weeks or months to several years. However, the in-line pressure detector with alarms is sufficient to provide the homeowner with warning that the water may be contaminated so it may be used independently and separately from the other modules, as can each of the other modules, and would as such be another embodiment of this invention which may use only a single parameter or only two parameters to test for problems with the water supply.

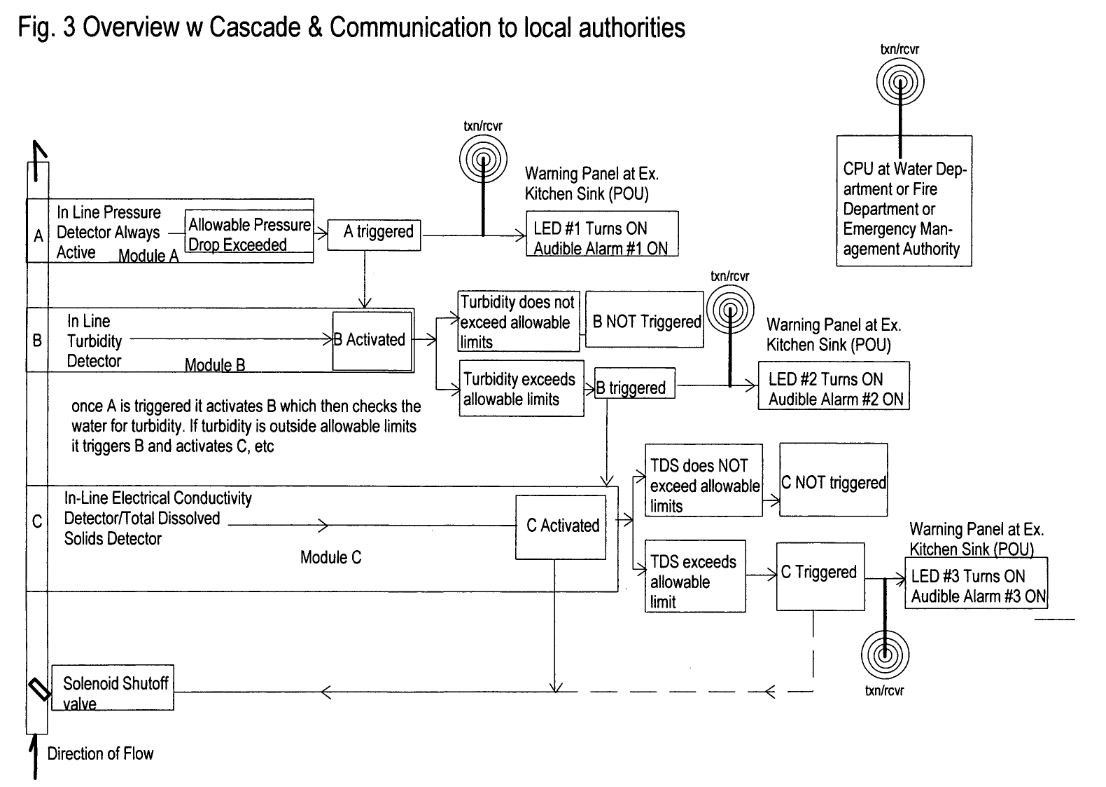

In one embodiment of the invention the in-line turbidity detector would operate, in principle, in a fashion similar to, but independently from, the in-line pressure detector module. Referring again to FIG. 1, the in line turbidity detector, being much more sensitive than the human eye, could be set to switch power on to an LED and audible alarm at the point of use (ex kitchen sink) once activated by water if it has changes in turbidity outside the preset limits. Thus there would now be a single LED and audible alarm (LED #2 and alarm #2) which would be activated and indicate a change in turbidity that may indicate serious problems with the quality of the water entering the home. As with the pressure and conductivity, the turbidity can be set at the time of installation by a technician familiar with the normals for these parameters and being able to make adjustments for variations that could be considered within normal limits. These adjustments would be made at, referring now to FIG. 3, module A, or module B, or Module C at the time of installation. It is also possible to make adjustments in any of these settings at some later time if conditions warrant it.

In one embodiment of the invention the in-line conductivity detector would operate, in principle, in a fashion similar to, but independently from, the other two detector modules. Referring again to FIG. 1, the in line conductivity (TDS or EC electrical conductivity) detector may be set to activate its audible alarm and LED when the conductivity or total dissolved solids exceed certain acceptable limits. Again, these limits can be determined and set by a relatively unskilled technician at the time of installation.

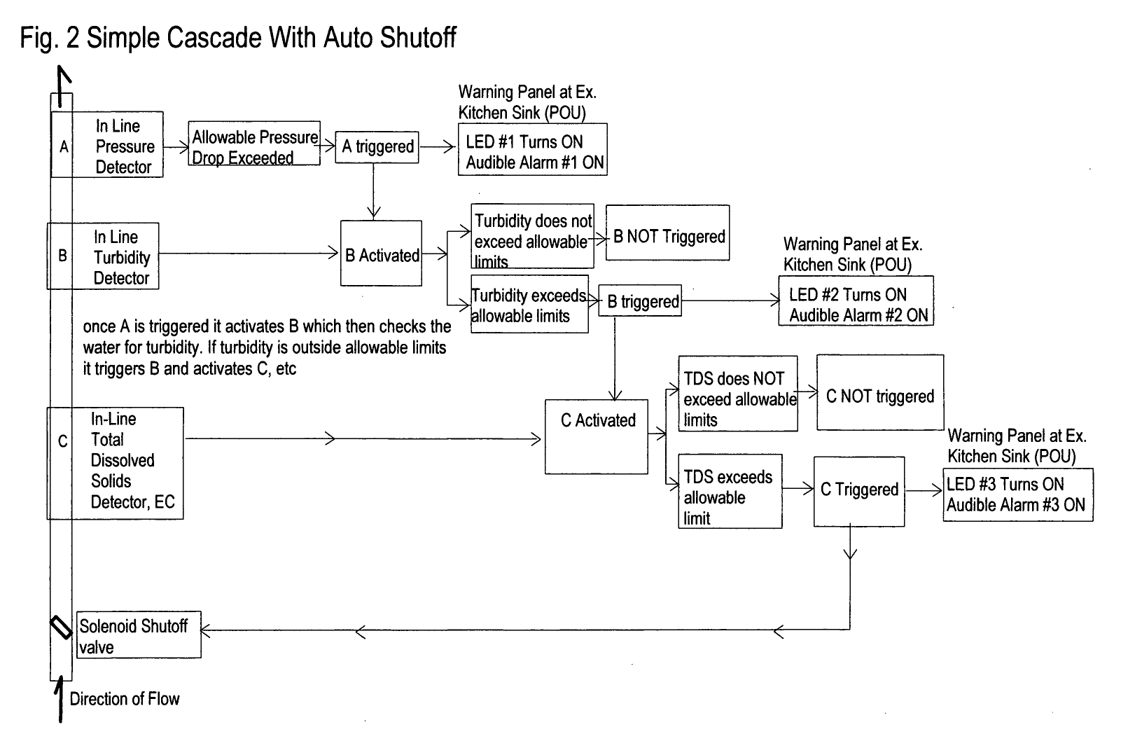

Another embodiment of the invention uses a cascade to improve efficiency, reduce false alarms, and make the system more dependable. This can be a most important feature. Referring to FIG. 2 it can be seen that in the starting condition the in line pressure detector means is powered and active. Thus a pressure change will trigger it to produce an alarm and illuminate a means for illumination as in the previous description. But in addition, when A (referring to FIG. 2) is triggered it activates or powers B (the in line turbidity detector). B in turn will measure turbidity in the water stream and if turbidity is outside acceptable limits will trigger LED #2 and Audible alarm #2 to become active. At this point, if both parameters are outside normal limits, both LED #1 and LED #2 of the point of use (POU) warning panel will be illuminated and sounding an alarm. When B is triggered it now also activates C the inline total dissolved solids detector and allows it to begin its detection functions. Once again, if TDS is outside the normal limits a third LED, LED #3 and a third audible alarm (FIG. 2 audible alarm #3) will be activated and when C triggers it also is connected to the shutoff valve with such means as to allow the valve to shut off the water supply to the residence to protect the end user. The reset on the warning panel will also reset the shutoff valve to the open position so the end user can access the water in the distribution system again if needed. Thus another embodiment of the invention includes a means for shutting the water supply to the home off until the water is deemed safe to drink. This may be a solenoid operated shutoff valve or some other means for stopping water flow into the monitored distribution system.

While we have used LED's in these examples and embodiments any appropriate means of illumination may be used in this invention. The preceding descriptions should not be taken as the only means for accomplishing the results or limiting the scope of the invention and any other means for accomplishing the same result should be taken as being within the scope of this invention.

Referring now to FIG. 3 it can be seen that the same cascading system can be equipped with radio transmission and receiving devices that can perform additional functions or perform some functions already cited in this document, for example communication between modules and the point of use warning panel. FIG. 3 describes one possible, but not to be interpreted as the only, method for using an in-home system to alert authorities to problems with the water distribution system or the quality of water within that system or the possible contamination of water within the in home system or the larger community water distribution system. This would be a very useful tool for preventing accidental or intentional contamination of water in the distribution system from harming residents who are using the system and alerting authorities to problems or attempts by terrorist activities to harm the public at a level in the system where monitoring is currently either seldom or never conducted. One embodiment will have a radio signal with appropriate information sent out to a receiver at a local monitoring agency such as an emergency preparedness unit or fire department or water purification plant or other relevant monitoring facility and location. Encoded in the transmission will be the location and specific parameter which is outside normal limits and the actual values by which it deviates and other important data such as the time and possibly GPS coordinates or addresses. These are easily accomplished with today's technology as is generally known and will be understood by one knowledgeable in the art. With a cascading system the data will be much more reliable than without because it relies on internal checks for validity of the data.

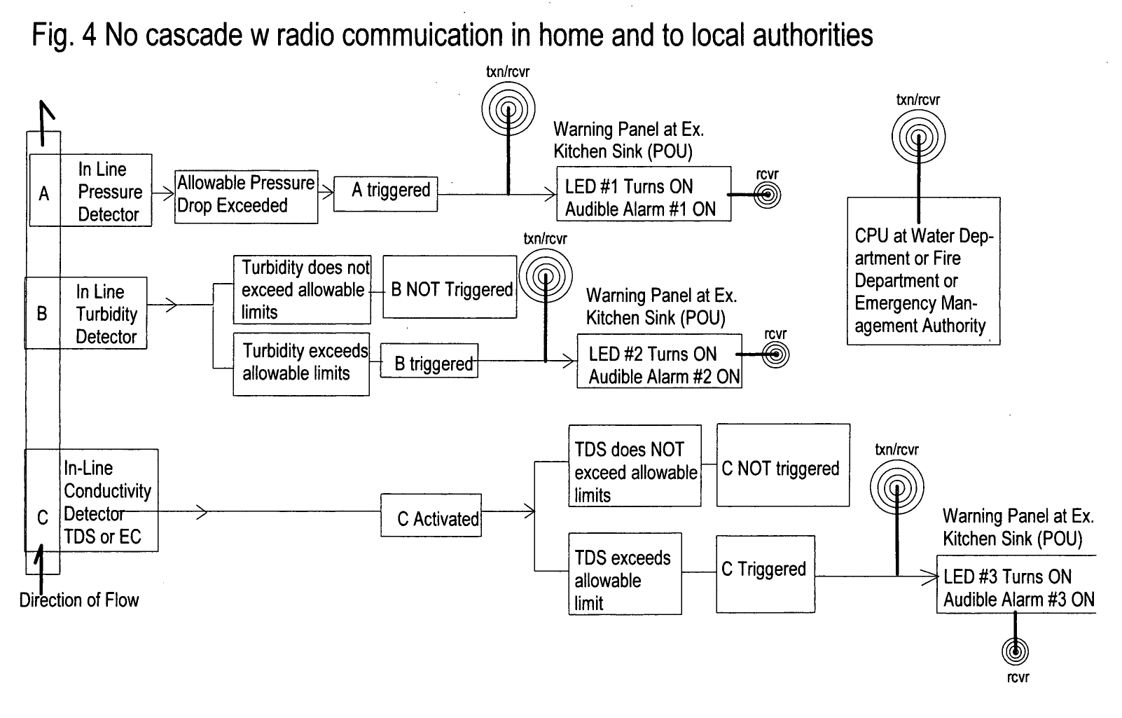

Referring now to FIG. 4 it can be seen that radio communication can replace hard wired devices even within the home water distribution system. In this embodiment the transceiver sends a signal from the module located in the incoming water line to the warning panel at the point of use. At the same time the signal can be relayed to the local authorities to warn them.

Inherent in the embodiments herein described is the possibility for many different combinations of parameters, order of parameter testing, methods for signaling and a variety of other variables that can be changed and recombined in a very large number of possible combinations. In addition, new parameters could be added which have not been included in this discussion, but would be well within the proposed concept of monitoring and reporting. One example is the addition of modules that monitor for specific compounds or elements such as arsenic or lead or nitrate or hardness etc. We believe such combinations should, and parameters may be considered to be within the scope of this patent.

What is claimed is:

1. A contaminated water detecting and monitoring and warning device comprising a plurality of components, units and modules installed in a water distribution system in which said components, units, and modules allowing detection of contamination or potential contamination of, and intrusion of contaminants into, the water supply and may be used to alert the user to that potential contamination and in at least one embodiment regulate the water supply and signal to an onsite and an offsite data collection and processing unit the readouts of the detecting units and condition of the water flowing through said device for purposes of alerting public officials and protecting private individuals and the public from contamination in their water supply.
Said monitoring device comprising at least one or more of the following
A. A module that monitors water pressure (herein called module A), and a second module which monitors water turbidity (herein called module B), and a third module which monitors water electrical conductivity and electrical resistance and total dissolved solids (TDS) (herein called module C) contained within a water distribution system, water line, water conduit, and water pipe.
B. Each module is a means for detecting changes in water quality and communicating said changes to an observer or user of that water
a. Module A comprises an in-line water pressure monitor and switch which may monitor and test water pressure within a conduit of the water distribution system and relay a signal to module A of the warning panel by activating a visual alarm (LED) and an audible alarm to indicated that water pressure has exceeded the set points and acceptable limits of water pressure established for the system
b. Module B comprises an in-line turbidity detector and switch which may monitor and test the turbidity of the water within the conduit of the water distribution system and send an activation signal to the module B of the warning panel to trigger the visible (LED) alarm and the audible alarm that the turbidity has exceeded the set points and acceptable limits of turbidity established for the system
c. Module C comprises an in line electrical conductivity and electrical resistivity and total dissolved solids detector and switch
i. said detector may detect electrical conductivity and total dissolved solids and electrical resistance of the water in the water distribution system
ii. said switch may send a signal to the stage C of the warning panel when a preset limit of resistance and conductivity and dissolved solids value established for the system, is or are exceeded
C. The device may comprise either module A operating singly or module A plus module B operating singly or simultaneously or in tandem, or module A plus module B plus module C operation singly, together simultaneously or together in tandem. The order of tandem, or cascade operation in all cases being variable according to need or desired result.
D. Each module contains a means to measure at least one parameter said parameters being at least water pressure and water turbidity and total dissolved solids and electrical conductivity and electrical resistance of the water in the system
E. Each module with a means to send a signal to and to trigger an audible and a visual alarm on a warning panel located above the most common point of use of the water distribution system
F. Each module may provide the user with information regarding the condition of the water distribution system and the water within the water distribution system by means of the alarm on the warning panel linked or connected to the particular module in question
G. Said device may be connected so as to shut off water supply at a valve located near the point of entry to prevent consumption or use of contaminated water for other purposes such as showering, washing clothing, making ice in an ice making machine, or by other water utilizing devices
H. Each module with the capacity to connect directly or indirectly to any other module and possibly regulate activation power to that module.
I. Each module may provide the user with information regarding the condition of the water distribution system and the water within the water distribution system by means of any reasonable alternative to the alarm on the warning panel associated with the particular module in question such as by example a gauge or meter
J. A module (Module A) which can detect when water pressure exceeds certain set limits
Said module A which may detect when water pressure drops below a preset value
Said preset value defines the lowest pressure being deemed acceptable in the water distribution system without contaminants entering the system
One embodiment may for example use 20 psi as one acceptable value (psi=pounds per square inch) but other values may be used depending upon circumstances
Said module A which is connected to an warning panel A located above the most common point of use of the water in the distribution system. In one preferred embodiment said warning panel A would be above the kitchen sink faucet since that is a very common point of use.
In one preferred embodiment said module A may close an electrical connection thus turning on and activating a multiplicity of additional modules comprising at least a power supply to module B and warning panel A comprising and therefore activating a 1) source of illumination (LED) thus illuminating the LED, 2) an audible alarm (thus sounding the audible alarm), and 3) a second stage of the device (stage B) thus turning on and activating the turbidimeter (turbidity detector) and powering that stage of the device which may now measure/test the turbidity of the solution within the distribution system.
Warning panel A in which a display which includes a source of illumination (LED), an audible alarm, and on-off switches for each and a reset button are located at the most common point of use, usually above the kitchen faucet installed in any of a plurality of places such as the wall, or counter, on the sink itself, the backsplash or elsewhere where they are readily visible and accessible.
A device in which the connection from detector unit/module to the display at the point of use may be hard wired or transmitted by electronic signal via electromagnetic (EM) waves such as radio frequency waves, microwaves, or other appropriate EM signals The module A, which will trigger no changes when the distribution system pressure remains within the acceptable range as defined by the preset value
K. A module (Module B) which can detect when in-line turbidity exceeds a certain set limit
A module or turbidimeter, which can detect when in line turbidity, exceeds any value between 0 and 2000 NTU (nephelometric turbidity units)
Said turbidimeter, which in one preferred embodiment, could be set to detect a value of between 0 and 1 NTU and above that range would close an electrical connection thus turning on and activating a plurality of devices comprising at least a power supply and a 1) source of illumination, an LED, thus illuminating the LED, and 2) an audible alarm (thus sounding the audible alarm), and 3) a third stage of the device (stage/module C) thus turning on and activating the conductivity detector which may now sample and test the conductivity of the solution in the pipe of the water distribution system
Said contaminated water warning, detection and monitoring device comprising a warning panel on which a display which includes a means of illumination (ex. LED), a means for an audible alarm, and on-off switches for each and a reset button are located at the most common point of use, preferably above the kitchen faucet and sink installed in any of a plurality of places such as the wall, or counter, on the sink itself, the backsplash or elsewhere where they are readily visible and accessible.
Said contaminated water warning, detection and monitoring device comprising a device in which the connection from detector unit/module to the display at the point of use may be hard wired or transmitted by electronic signal via electromagnetic waves such as radio frequency waves.
The module A, which will trigger no changes when the distribution system pressure remains within the acceptable range as defined by the preset value
Said contaminated water warning, detection and monitoring device comprising a means of illumination may use visible, infrared or ultraviolet (UV) light to detect a variety of organic and inorganic substances including nucleic acids such as DNA and RNA at frequencies of approximately 260 nm (nanometers) for nucleic acids and proteins and amino acids at approximately 280 nanometers for proteins and amino acids and like absorbing substances
Said contaminated water warning, detection and monitoring device comprising a means for illumination using visible, infrared or UV light to detect turbidity at a preferred wavelength or combination of wavelengths dependent upon the desired target compound or particle
Said contaminated water warning, detection and monitoring device comprising any combination of appropriate wavelengths of visible, infrared and UV light to detect turbidity
L. A module (C) which can detect when in-line conductivity and resistivity and TDS exceeds certain set limits
said module which can detect when in line conductivity in the water distribution system exceeds any preset value corresponding to between 0 and 16 Megohms (16-18 Megohms being extremely pure water)
said preset value defining the LOWEST conductivity value or the HIGHEST resistivity value that will be acceptable for the particular distribution system in which module C is installed
said lowest conductivity value being chosen may be a value corresponding to a lowest excursion of the parameter of the normal water supply under usual conditions or a predetermined value which the end user decides is acceptable to them.
said highest resistivity value being chosen may be a value corresponding to a highest expected excursion of the resistivity of the normal water supply under usual conditions or a predetermined value which the end-user may decide is acceptable to them.
Any of these values will correspond to a specific value of TDS (total dissolved solids) in the water of the distribution system.
The chosen values which may be adjusted by a technician on site using a means to adjust an appropriate electrical property of the module and device perhaps using an integrated potentiometer or other appropriate electronic adjustment means and outside that range of values would close an electrical or electronic or physical connection thus turning on and activating at least a power supply and a 1) source of illumination, an LED thus illuminating the LED, and 2) an audible alarm (thus sounding the audible alarm).
Said contaminated water warning, detection and monitoring device comprising a module in which a display which includes a means of illumination (LED), an audible alarm, and on-off switch means for each module and a reset button for each module located at the most common point of use, usually above the kitchen faucet installed in any of a plurality of places such as the wall, or counter, on the sink itself, the backsplash or elsewhere where they are readily visible and accessible.
Said contaminated water warning, detection and monitoring device comprising a device in which the connection from detector unit/module to the display at the point of use may be hard wired or transmitted by electronic signal via electromagnetic waves such as radio frequency waves.

2. What is claimed is a water distribution system monitoring, warning and testing device
Said device comprising a pressure detector with sender unit to send a signal to a warning panel located at the most common or convenient point of use or point of observation
Said device comprising an on-off switch connected to the pressure detector which is activated when the pressure excursions are outside the acceptable set limits
Said device comprising an on-off switch for each detector and sender which turns on and stays on until reset when activated by an excursion of the measured parameter beyond the limits established for that parameter
Said device comprising a sender unit to send a signal to a warning panel located at the most common or convenient point of use and a central data processing station either on site or off site to collect data and inform appropriate agencies of deviations of that parameter from the normal range of values
Said device comprising a turbidity detector with sender unit to send a signal to a warning panel located at the most common or convenient point of use
Said device comprising an on-off switch connected to the turbidity detector which is activated when the turbidity excursions are outside the acceptable set limits
Said device comprising an on-off switch for each detector and sender which turns on and stays on until reset when activated by an excursion of the measured parameter beyond the limits established for that parameter
Said device comprising a sender unit to send a signal to a warning panel located at the most common or convenient point of use and a central data processing station either on site or off site to collect data and inform appropriate agencies of deviations of that parameter from the normal range of values
Said device having units interconnected by either hard wiring or electromagnetic signaling such as a radio signal, microwave signal, infrared signal and others
Said device comprising an electrical conductivity and total dissolved solids detector which detector is connected to a sender unit to send a signal to a warning panel located at the most common or convenient point of use
Said device comprising an on-off switch connected to the electrical conductivity and total dissolved solids detector which is activated when the electrical conductivity and total dissolved solids excursions are outside the acceptable set limits
Said device comprising an on-off switch for each detector and sender which turns on and stays on until reset when activated by an excursion of the measured parameter beyond the limits established for that parameter
Said device comprising a sender unit to send a signal to a warning panel located at the most common or convenient point of use and a central data processing station either on site or off site to collect data and inform appropriate agencies of deviations of that parameter from the normal range of values
Said device comprising a warning panel to receive the signals
said panel being located at the most common or convenient point of use for example above the kitchen sink or at an appropriate location in an on-site or off-site monitoring facility
Said warning panel comprising a means for providing a visual signal as an example, an LED or similar means for illumination
Said warning panel comprising a means for providing an audible signal for example only, a siren or chime
Said warning panel having said audible and visual signals labeled and modulated to indicate which parameter the signal indicates as being out of its acceptable range
Said warning panel having a reset feature that allows any and each of the parameter detectors and indicators to be reset to the resting and inactive and quiescent state
Said warning panel may have a radio, infrared, microwave or other electromagnetic based signal processor and sender and receiver to be used for notification of on-site or off-site observers and monitors
Said warning panel comprising a receiver unit capable of receipt, processing, and interpreting input from the detector sender units
Said device comprising a means for switching connected to the detector modules and warning panel units
Said means for switching communicating with the detector modules, units and modules
Said means for switching controlling power to either or both audible and visual alarms
Said means for switching controlling power to either, both, or all three detectors
Said means for switching being connected to a signal sending unit capable of sending a signal locally or off-site to a receiver unit
Said device having a source of power such as a battery or dc power from a transformer from an in-home or facility power supply
Said device in a third embodiment having one or two or all three of the detector means for switching connected to a solenoid that turns off the water supply at a particular location in the distribution system so as to protect the distribution system and water utilizing devices in the distribution system from damage due to changes in pressure, turbidity, or dissolved solids levels.
Said device having one or two or all three of the detector means either individually or in some tandem arrangement connected so as to be able to turn the water source to the distribution system off when excursions of either pressure, turbidity, or dissolved solids and either pressure and turbidity or pressure and dissolved solids or turbidity and dissolved solids, or all three values exceed the prescribed limits
Said device having detector means arranged in tandem cascade such that detector means for unit A triggers a switch means to power on unit B which in turn triggers a switch means to provide power to unit C. Signals from a combination of all three units indicating said units are outside acceptable ranges and being required to shut water off to local distribution system

3. What is claimed is a method for detecting and monitoring and warning of potential contamination of a water supply using a device comprising a plurality of components, units and modules installed in a water distribution system in which said components, units, and modules allowing detection of contamination or potential contamination of, and intrusion of contaminants into, the water supply and may be used to alert the user to that potential contamination and in at least one embodiment regulate the water supply and signal to an onsite and an offsite data collection and processing unit the readouts of the detecting units and condition of the water flowing through said device for purposes of alerting public officials and protecting private individuals and the public from contamination in their water supply.
